(19) United States
(12) Patent Application Publication
(10) Pub. No.: US 2025/0316814 A1
(43) Pub. Date: Oct. 9, 2025

(54) BATTERY PACK

(71) Applicants: Hyundai Motor Company, Seoul (KR); Kia Corporation, Seoul (KR)

(72) Inventor: Hyun Ho Lee, Hwaseong-si (KR)

(21) Appl. No.: 18/938,571

(22) Filed: Nov. 6, 2024

(30) Foreign Application Priority Data
Apr. 8, 2024 (KR) 10-2024-0047546

(51) Int. Cl. H01M 50/24; H01M 50/204; H01M 50/271; H01M 50/298; H01M 50/507

(52) U.S. Cl. CPC H01M 50/24; H01M 50/204; H01M 50/271; H01M 50/298; H01M 50/507

(57) ABSTRACT

An embodiment battery pack includes a battery housing defining a receiving space, a plurality of battery modules accommodated in the receiving space, each battery module comprising a battery cell, a busbar electrically connected to the battery cell and disposed on a first side of the battery modules, and a fireproof member disposed between the busbar and the battery modules, the fireproof member extending to cover the busbar.

### CROSS-REFERENCE TO RELATED APPLICATIONS

This application claims the benefit of Korean Patent Application No. 10-20240047546, filed on Apr. 8, 2024, which application is hereby incorporated herein by reference.

### TECHNICAL FIELD

The present disclosure relates to a battery pack.

### BACKGROUND

In recent years, research and development on electric vehicles, which are environmentally friendly vehicles, has been emphasized as crisis awareness of environments and oil resource depletion has increased. The electric vehicles include a plug-in hybrid electric vehicle (PHEV), a battery electric vehicle (BEV), a fuel cell electric vehicle (FCEV), and the like.

An electric vehicle may include battery modules and a battery pack housing supporting the battery modules. The electric vehicle uses battery cells of the battery modules as a power source, and it is necessary to sense the voltages of the battery modules or supply power to the battery modules.

A battery pack may include a busbar or wire electrically connected to the battery modules. If a short circuit occurs in the busbar or wire when a fire occurs in the battery pack, a thermal runaway phenomenon may occur. Accordingly, a battery pack for preventing a thermal runaway phenomenon is required.

### SUMMARY

Embodiments of the present disclosure can solve problems occurring in the prior art while advantages achieved by the prior art are maintained intact.

An embodiment of the present disclosure provides a battery pack for preventing a short circuit using a fireproof member disposed between a busbar and battery modules.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, a battery pack includes a battery housing that forms a receiving space, a plurality of battery modules accommodated in the receiving space, each battery module including a battery cell, a busbar electrically connected to the battery cell and disposed on a first side of the battery modules, and a fireproof member that is disposed between the busbar and the battery modules and that extends to cover the busbar.

The fireproof member may physically contact with the battery modules.

The busbar may include a first busbar that extends in a front-rear direction of the battery housing and a second busbar that electrically connects the plurality of battery modules.

The fireproof member may include a first fireproof area disposed between the first busbar and the battery modules and a second fireproof area disposed between the second busbar and the battery modules.

The battery housing may include a base plate and a longitudinal support member that is supported by the base plate and that extends in the front-rear direction. The battery modules may include a first battery module and a second battery module disposed to face each other with the longitudinal support member therebetween.

The battery pack may include a first wire that extends in the front-rear direction of the battery housing between the first battery module and the second battery module and a first wire fireproof member disposed between the first wire and the first and second battery modules.

The first wire fireproof member may include a first-first wire fireproof area disposed between the first wire and the first battery module, a first-second wire fireproof area disposed between the first wire and the second battery module, and a first-third wire fireproof area that is disposed under the first wire and that connects the first-first wire fireproof area and the first-second wire fireproof area.

The battery housing may include a base plate and a lateral support member that is supported by the base plate and that extends in a left-right direction. The battery modules may include a third battery module and a fourth battery module disposed to face each other with the lateral support member therebetween.

The battery pack may further include a second wire that is disposed between the lateral support member and the third battery module or the fourth battery module, that extends parallel to the lateral support member and a second wire fireproof member disposed between the second wire and the lateral support member.

The second wire fireproof member may include a second-first wire fireproof area that is disposed between the lateral support member and the second wire and that covers a first side of the lateral support member.

The second wire fireproof member may further include a second-second wire fireproof area that protrudes from the second-first wire fireproof area and extends to surround the second wire together with the second-first wire fireproof area.

The fireproof member may comprise mica, gel, and tape.

According to an embodiment of the present disclosure, a battery pack includes a battery housing defining a receiving space, a plurality of battery modules accommodated in the receiving space, each battery module comprising a battery cell, a busbar electrically connected to the battery cell and disposed on a first side of the battery modules, a fireproof member disposed between the busbar and the battery modules, the fireproof member extending to cover the busbar, a pack cover disposed above the busbar and a cover fireproof member that is disposed between the pack cover and the busbar and that extends to cover the busbar.

The pack cover may comprise an injection moldable material.

The cover fireproof member may be physically contact with the pack cover.

A width of the cover fireproof member may be thinner than a width of the fireproof member.

The cover fireproof member may contact one of mica, gel, and tape.

the busbar may comprise a first busbar extending in a front-rear direction of the battery housing and a second busbar electrically connecting the plurality of battery modules. The fireproof member may comprise a first fireproof area disposed between the first busbar and the battery modules and a second fireproof area disposed between the second busbar and the battery modules.

The battery housing may comprise a base plate and a longitudinal support member supported by the base plate and extending in the front-rear direction, the battery modules comprise a first battery module and a second battery module disposed to face each other with the longitudinal support member therebetween. The battery pack may further comprise a first wire extending in the front-rear direction of the battery housing between the first battery module and the second battery module and a first wire fireproof member disposed between the first wire and the first and second battery modules, wherein the first wire fireproof member comprises a first-first wire fireproof area disposed between the first wire and the first battery module, a first-second wire fireproof area disposed between the first wire and the second battery module and a first-third wire fireproof area disposed under the first wire and connecting the first-first wire fireproof area and the first-second wire fireproof area.

The battery housing may comprise a base plate and a lateral support member supported by the base plate and extending in a left-right direction. The battery modules may comprise a third battery module and a fourth battery module disposed to face each other with the lateral support member therebetween. The battery pack may further comprise a second wire disposed between the lateral support member and the third battery module or the fourth battery module, the second wire extending parallel to the lateral support member and a second wire fireproof member disposed between the second wire and the lateral support member, wherein the second wire fireproof member comprises a second-first wire fireproof area disposed between the lateral support member and the second wire and covering a first side of the lateral support member and a second-second wire fireproof area protruding from the second-first wire fireproof area and extending to surround the second wire together with the second-first wire fireproof area.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 is a plan view of a battery pack according to an embodiment of the present disclosure;

FIG. 2 is an exploded perspective view of the battery pack according to an embodiment of the present disclosure;

FIG. 3 is a perspective view of battery modules, a battery housing, a busbar, and surrounding components according to an embodiment of the present disclosure;

FIG. 4 is a vertical sectional view taken along line A-A illustrated in FIG. 1; and

FIG. 5 is a vertical sectional view taken along line B-B illustrated in FIG. 1.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when it is displayed on other drawings. Further, in describing the embodiments of the present disclosure, a detailed description of well-known features or functions will be omitted in order not to unnecessarily obscure the gist of the present disclosure.

In describing the components of the embodiments according to the present disclosure, terms such as first, second, “A,” “B,” (a), (b), and the like may be used. These terms are merely intended to distinguish one component from another component, and the terms do not limit the nature, sequence, or order of the components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and they are not to be interpreted as having ideal or excessively formal meanings unless clearly defined as having such in the present application.

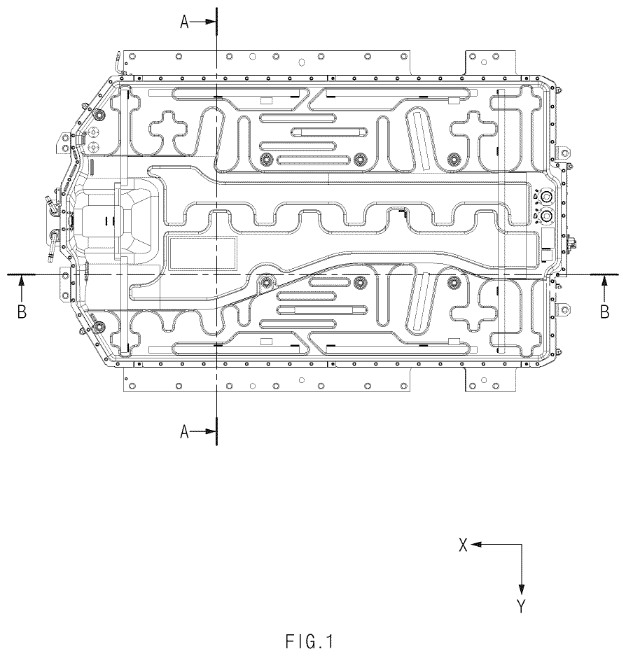

Hereinafter, embodiments of the present disclosure will be described in detail with reference to FIGS. 1 to 5.

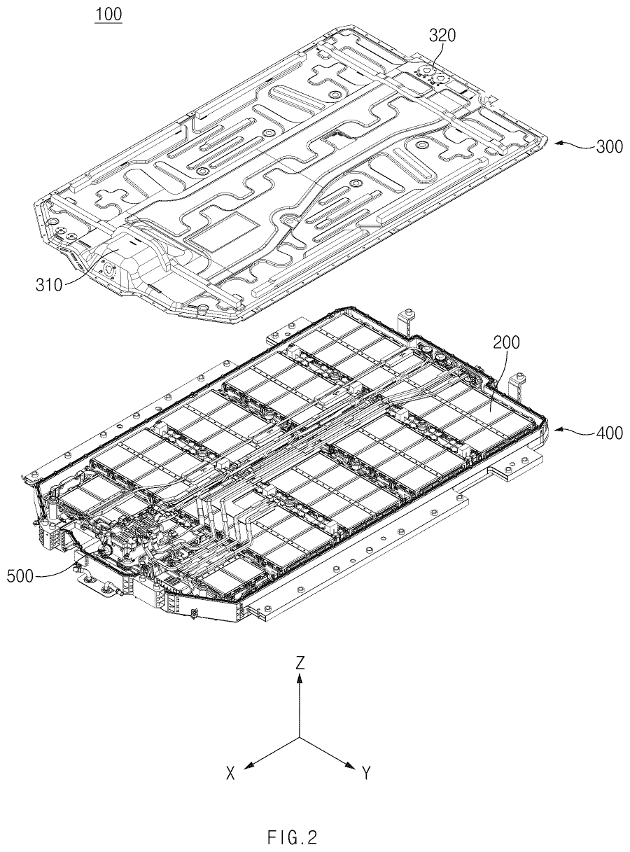

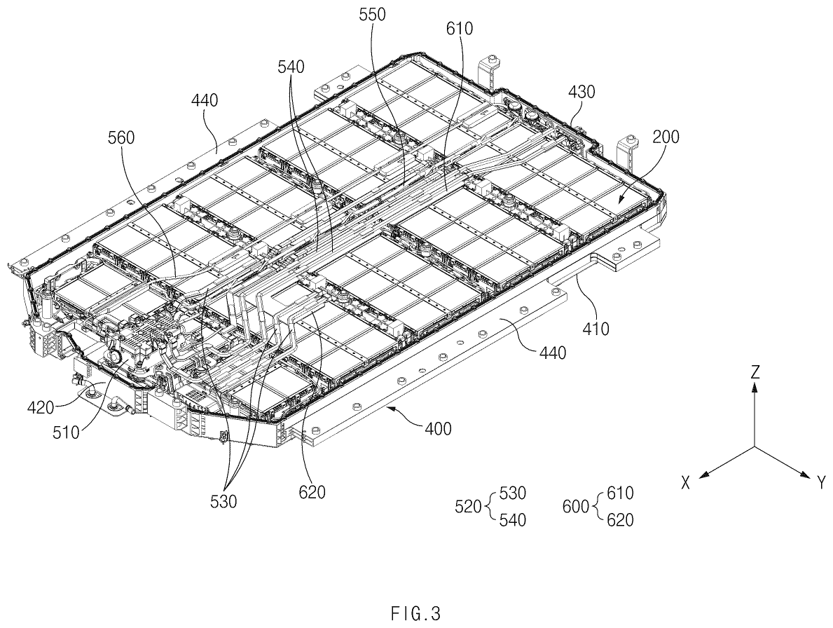

FIG. 1 is a plan view of a battery pack according to an embodiment of the present disclosure. FIG. 2 is an exploded perspective view of the battery pack according to an embodiment of the present disclosure. FIG. 3 is a perspective view of battery modules, a battery housing, a busbar, and surrounding components according to an embodiment of the present disclosure.

Referring to FIGS. 1 to 3, the battery pack 100 may include a plurality of battery modules 200, a pack cover 300 disposed above the plurality of battery modules 200 (in the Z-direction), and a battery housing 400 supporting the plurality of battery modules 200.

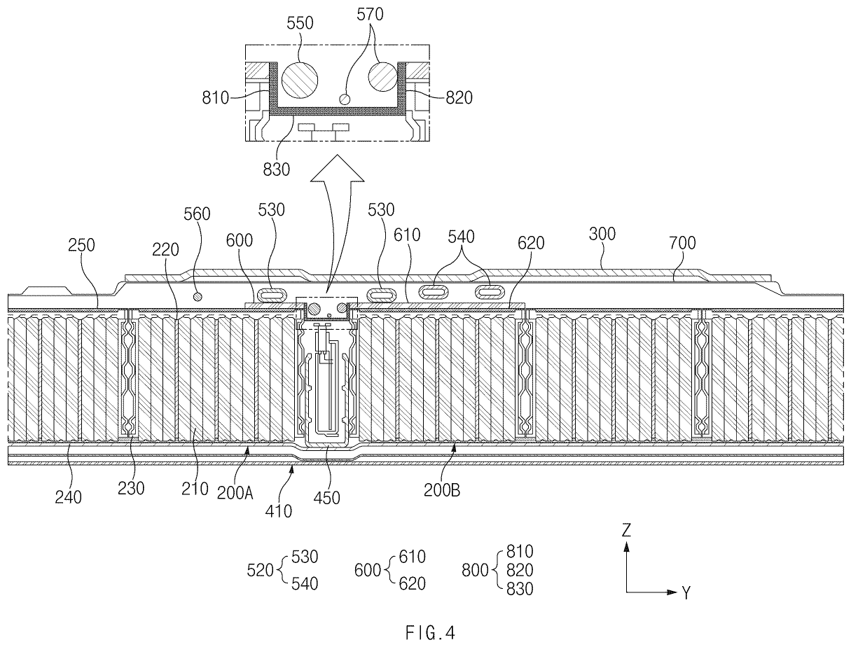

Each of the battery modules 200 may include a plurality of battery cells 210 (refer to FIG. 4). Each of the battery cells 210 may be implemented with a lithium ion battery, but is not limited thereto. The plurality of battery modules 200 may be supported by the battery housing 400. At least two battery modules 200 among the plurality of battery modules 200 may be spaced apart from each other in the front-rear direction (the X-direction or the direction opposite to the X-direction) or in the left-right direction (the Y-direction or the direction opposite to the Y-direction).

The pack cover 300 may cover upper areas of the battery modules 200 (in the Z-direction). The pack cover 300 may include a first venting valve 310 formed at the front and a second venting valve 320 formed at the rear.

The first venting valve 310 and the second venting valve 320 may be components for venting flames or high-temperature gases to the outside of the battery pack 100 when a fire occurs in the battery pack 100.

The pack cover 300 may be formed of an injection moldable material. The reason why the pack cover 300 is formed of the injection moldable material is to reduce the weight as compared with when the pack cover 300 is formed of another material.

The battery housing 400 may include a base plate 410 disposed under the battery modules 200 (in the direction opposite to the Z-direction) to support the battery modules 200, a front member 420 disposed in front of the battery modules 200, and a rear member 430 disposed behind the battery modules 200.

The battery housing 400 may include a side member 440 extending in the front-rear direction to connect the front member 420 and the rear member 430. A pair of side members 440 may be provided. The side members 440 may be disposed on the opposite sides of the battery modules 200 in the left-right direction.

The battery housing 400 may form a receiving space surrounded by the base plate 410, the front member 420, the rear member 430, and the side members 440. The receiving space may be a space for accommodating the plurality of battery modules 200. Accordingly, the battery modules 200 may be disposed in the receiving space, which is formed by the front member 420, the rear member 430, and the side members 440, while being supported by the base plate 410.

The battery pack 100 may include an electronic module 500 for controlling the battery modules 200 or for transmitting power generated from the battery modules 200 to other components of a vehicle. The electronic module 500 may include a power relay assembly 510 and a busbar 520.

The power relay assembly 510 may be a component for connecting the power generated from the battery modules 200 to the other components of the vehicle or for disconnecting the power from the other components of the vehicle. The power relay assembly 510 may be disposed adjacent to the front member 420.

The busbar 520 may include a first busbar 530 extending in the front-rear direction of the battery housing 400 and a second busbar 540 electrically connecting the plurality of battery modules 200.

The first busbar 530 may be a high-current busbar. The high-current busbar may be a busbar through which a relatively high current flows within the battery pack 100 according to embodiments of the present disclosure. The first busbar 530 may be connected to the power relay assembly 510. The first busbar 530 may be connected with a high-voltage connector provided at at least one of the front and rear of the battery housing 400. The first busbar 530 may supply power to the other components of the vehicle provided at the front and rear of the battery pack 100.

The second busbar 540 may be a module busbar. That is, the second busbar 540 may be accommodated in the battery housing 400 and may electrically connect the plurality of battery modules 200. The second busbar 540 may be connected to the power relay assembly 510.

The electronic module 500 may include a communication wire 550 connected to the battery cells 210 of the battery modules 200. The communication wire 550 may be connected to a battery management system (BMS) (not illustrated) and the power relay assembly 510 to transmit information about the voltage or temperature of the battery cells 210 to the BMS and the power relay assembly 510. The communication wire 550 may extend in the front-rear direction of the battery housing 400.

The electronic module 500 may include a side wire 560 disposed above the battery modules 200. The side wire 560 may be disposed on the right side of the battery housing 400 (in the direction opposite to the Y-direction).

The first busbar 530, the second busbar 540, the communication wire 550, and the side wire 560 may be disposed above the battery modules 200 or on one side of the battery modules 200 in the left-right direction. The first busbar 530, the second busbar 540, the communication wire 550, and the side wire 560 may be supported by a separate support frame.

When a fire occurs in the battery pack 100, the battery modules 200 and the pack cover 300 may be melted due to flames or high-temperature gases caused by the fire. When the battery modules 200 or the pack cover 300 is melted, a short circuit may occur in the busbar 520 disposed adjacent to the area where the pack cover 300 is melted.

To prevent this phenomenon, the battery pack 100 may include a fireproof member 600 that is disposed between the busbar 520 and the battery modules 200 and that extends to cover the busbar 520.

The fireproof member 600 may be disposed between a partial region of the busbar 520 and the battery modules 200. The fireproof member 600 may be brought into contact with the battery modules 200. In addition, the fireproof member 600 may be supported by the battery modules 200 and may be bonded to the battery modules 200. The fireproof member 600 may be implemented with one of mica, gel, and tape.

The fireproof member 600 may include a first fireproof area 610 disposed between the first busbar 530 and the battery modules 200 and a second fireproof area 620 disposed between the second busbar 540 and the battery modules 200.

The first fireproof area 610 may be a portion of the fireproof member 600 that extends in the front-rear direction. The second fireproof area 620 may be a portion of the fireproof member 600 that extends from the first fireproof area 610 to one side in the left-right direction.

The first fireproof area 610 may space the first busbar 530 and the battery modules 200 apart from each other to prevent a short circuit from occurring in the first busbar 530. The second fireproof area 620 may space the second busbar 540 and the battery modules 200 apart from each other to prevent a short circuit from occurring in the second busbar 540. FIG. 4 is a vertical sectional view taken along line A-A illustrated in FIG. 1.

Referring to FIGS. 3 and 4, the battery housing 400 may include a longitudinal support member 450 that is supported by the base plate 410 and that extends in the front-rear direction. The longitudinal support member 450 may extend in the front-rear direction on the middle area of the battery housing 400 in the left-right direction.

The battery modules 200 may include a first battery module 200A and a second battery module 200B disposed to face each other with the longitudinal support member 450 therebetween. One of a pair of first busbars 530 may be provided above the first battery module 200A. The other one of the pair of first busbars 530 and a pair of second busbars 540 may be provided above the second battery module 200B.

A pair of fireproof members 600 may be provided. The fireproof member 600 disposed above the first battery module 200A may be a component for spacing the first busbar 530 and the first battery module 200A apart from each other. The fireproof member 600 disposed above the second battery module 200B may be a component for spacing the first and second busbars 530 and 540 and the second battery module 200B apart from each other.

The battery module 200 may include a surface pressure member 220 disposed between the plurality of battery cells 210, end plates 230 disposed on the opposite sides of the plurality of battery cells 210 in the left-right direction, and a module base 240 disposed under the plurality of battery cells 210. The battery module 200 may include a module cover 250 disposed above the plurality of battery cells 210.

The module cover 250 may be formed of an injection moldable material. Due to this, the module cover 250 may be melted when a fire occurs. The fireproof members 600 may be disposed between the module cover 250 and the first and second busbars 530 and 540 to prevent a short circuit from occurring in the first and second busbars 530 and 540 disposed adjacent to the area where the module cover 250 is melted.

The fireproof members 600 may be brought into close contact with the module cover 250. The fireproof members 600 may be brought into close contact with the module cover 250 by a separate adhesive member. Alternatively, the fireproof members 600 may be brought into close contact with the module cover 250 by an adhesive material applied to surfaces of the fireproof members 600 that face toward the module cover 250. The surfaces of the fireproof members 600 that face toward the module cover 250 may be provided to be easily bonded. For example, tapes may be provided on the surfaces of the fireproof members 600 that face toward the module cover 250.

The communication wire 550 and a longitudinal wire 570 may be provided above the longitudinal support member 450. The reason why the communication wire 550 and the longitudinal wire 570 are disposed above the longitudinal support member 450 is because it is advantageous in terms of the use of the inner space of the battery pack 100.

The communication wire 550 and the longitudinal wire 570 may be referred to as first wires 550 and 570. The first wires 550 and 570 may extend in the front-rear direction of the battery housing 400 between the first battery module 200A and the second battery module 200B.

The battery pack 100 may include a first wire fireproof member 800 formed between the first wires 550 and 570 and the first and second battery modules 200A and 200B. The first wire fireproof member 800 may be a component for spacing the first wires 550 and 570 apart from the first and second battery modules 200A and 200B.

The first wire fireproof member 800 may include a first-first wire fireproof area 810 disposed between the first wires 550 and 570 and the first battery module 200A and a first-second wire fireproof area 820 disposed between the first wires 550 and 570 and the second battery module 200B. The first wire fireproof member 800 may include a first-third wire fireproof area 830 that connects the first-first wire fireproof area 810 and the first-second wire fireproof area 820 and that is disposed under the first wires 550 and 570.

Since the first-first to first-third wire fireproof areas 810, 820, and 830 extend to surround the first wires 550 and 570, the first wires 550 and 570 and the first and second battery modules 200A and 200B may be spaced apart from each other. Accordingly, even though the first and second battery modules 200A and 200B are melted, a short circuit may be prevented from occurring in the first wires 550 and 570.

Meanwhile, the pack cover 300 may be provided above the first and second busbars 530 and 540. Since the pack cover 300 is formed of an injection moldable material, the pack cover 300 may be melted when a fire occurs in the battery pack 100.

When the melted area of the pack cover 300 is disposed adjacent to the first and second busbars 530 and 540 or falls onto the first and second busbars 530 and 540, a short circuit may occur in the first and second busbars 530 and 540.

To prevent this phenomenon, the battery pack 100 may include a cover fireproof member 700 that is disposed between the pack cover 300 and the first and second busbars 530 and 540 and that extends to cover the first and second busbars 530 and 540.

The cover fireproof member 700 may be disposed above the first and second busbars 530 and 540 and may be brought into contact with the lower surface of the pack cover 300. A width of the cover fireproof member 700 may be thinner than a width of the fireproof members 600. The cover fireproof member 700 may be brought into close contact with the lower surface of the pack cover 300. The cover fireproof member 700 may be implemented with one of mica, gel, and tape.

According to the above-described structure, even though the pack cover 300 is melted due to a fire occurring in the battery pack 100, a short circuit may be prevented from occurring in the first and second busbars 530 and 540. According to the same principle, even though the pack cover 300 is melted, a short circuit may be prevented from occurring in the first wires 550 and 570 and the side wire 560.

In addition, although not separately illustrated in the drawings, a separate fireproof member may be disposed between the first battery module 200A and the side wire 560 to prevent a short circuit from occurring in the side wire 560.

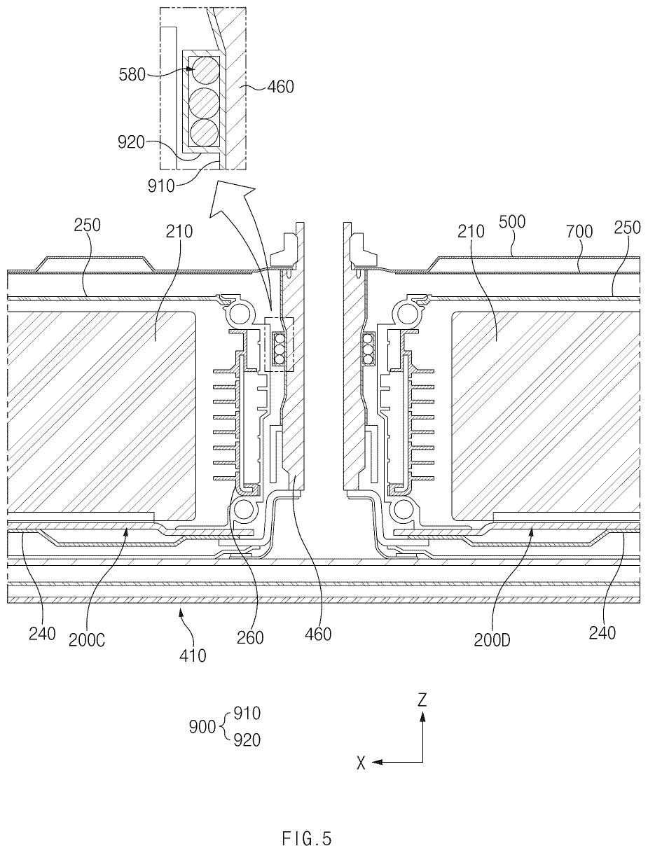

FIG. 5 is a vertical sectional view taken along line B-B illustrated in FIG. 1.

Referring to FIG. 5, the battery housing 400 (refer to FIG. 3) may include a lateral support member 460 that is supported by the base plate 410 and that extends in the left-right direction. The lateral support member 460 may be disposed between two adjacent battery modules 200 spaced apart from each other in the front-rear direction among the plurality of battery modules 200. The lateral support member 460 may be a pipe having a through space formed therein. A separate component required for the battery modules 200 may be accommodated in the lateral support member 460.

The battery modules 200 may include a third battery module 200C and a fourth battery module 200D disposed to face each other with the lateral support member 460 therebetween.

The battery pack 100 may include a second wire 580 disposed between one of the third and fourth battery modules 200C and 200D and the lateral support member 460. The second wire 580 may be disposed on the opposite sides of the lateral support member 460 in the front-rear direction and may extend parallel to the lateral support member 460.

When a fire occurs in the battery pack 100, flames or high-temperature gases may flow through the inside of the lateral support member 460. If the lateral support member 460 is melted, it is necessary to prevent a short circuit from occurring in the second wire 580 disposed adjacent to the melted area of the lateral support member 460.

Accordingly, the battery pack 100 may include a second wire fireproof member 900 formed between the second wire 580 and the lateral support member 460. The second wire fireproof member 900 may be a component for spacing the lateral support member 460 and the second wire 580 apart from each other.

The second wire fireproof member 900 may include a second-first wire fireproof area 910 that is disposed between the lateral support member 460 and the second wire 580 and that covers one side of the lateral support member 460 in the front-rear direction. The second wire fireproof member 900 may include a second-second wire fireproof area 920 protruding from the second-first wire fireproof area 910 to one side in the front-rear direction and extending to surround the second wire 580 together with the second-first wire fireproof area 910.

The second-first wire fireproof area 910 may be brought into contact with one surface of the lateral support member 460 that faces one side in the front-rear direction. The second-first wire fireproof area 910 may be brought into close contact with the lateral support member 460 and may be supported by the lateral support member 460. The second-second wire fireproof area 920 may be an area for spacing the third and fourth battery modules 200C and 200D and the second wire 580 apart from each other.

The second wire fireproof member 900 may be implemented with one of mica, gel, and tape. The second wire 580 may be spaced apart from the lateral support member 460 and the third and fourth battery modules 200C and 200D by the above-described structure. Accordingly, even though the lateral support member 460 or the third and fourth battery modules 200C and 200D are melted, a short circuit may be prevented from occurring in the second wire 580.

The above-described structure may prevent a short circuit from occurring in the busbar 520 (refer to FIG. 3) and the various types of wires 550, 560, 570, and 580 even when a fire occurs in the battery pack 100 (refer to FIG. 1), thereby preventing thermal runaway of the battery pack 100. Accordingly, the safety of the battery pack 100 may be improved.

According to embodiments of the present disclosure, the fireproof member may be disposed between the busbar and the battery modules to prevent a short circuit from occurring in the busbar, thereby preventing thermal runaway of the battery pack.

Furthermore, embodiments of the present disclosure may prevent a short circuit from occurring in the wire disposed in the battery pack, thereby preventing thermal runaway of the battery pack.

In addition, embodiments of the present disclosure may provide various effects that are directly or indirectly recognized.

Hereinabove, although embodiments of the present disclosure have been described with reference to exemplary embodiments and the accompanying drawings, the embodiments of the present disclosure are not limited thereto, but they may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure are not limited by the embodiments. The scope of the present disclosure should be construed on the basis of the accompanying claims, and all the technical ideas within the scope equivalent to the claims should be included in the scope of the present disclosure.

What is claimed is:

1. A battery pack comprising:
a battery housing defining a receiving space;
a plurality of battery modules accommodated in the receiving space, each battery module comprising a battery cell;
a busbar electrically connected to the battery cell and disposed on a first side of the battery modules; and
a fireproof member disposed between the busbar and the battery modules, the fireproof member extending to cover the busbar.

2. The battery pack of claim 1, wherein the fireproof member physically contacts the battery modules.

3. The battery pack of claim 1, wherein the busbar comprises:
a first busbar extending in a front-rear direction of the battery housing; and
a second busbar electrically connecting the plurality of battery modules.

4. The battery pack of claim 3, wherein the fireproof member comprises a first fireproof area disposed between the first busbar and the battery modules and a second fireproof area disposed between the second busbar and the battery modules.

5. The battery pack of claim 3, wherein:
the battery housing comprises a base plate and a longitudinal support member supported by the base plate and extending in the front-rear direction; and
the battery modules comprise a first battery module and a second battery module disposed to face each other with the longitudinal support member therebetween.

6. The battery pack of claim 5, wherein the battery pack further comprises:
a first wire extending in the front-rear direction of the battery housing between the first battery module and the second battery module; and
a first wire fireproof member disposed between the first wire and the first and second battery modules.

7. The battery pack of claim 6, wherein the first wire fireproof member comprises:
a first-first wire fireproof area disposed between the first wire and the first battery module;
a first-second wire fireproof area disposed between the first wire and the second battery module; and
a first-third wire fireproof area disposed under the first wire and connecting the first-first wire fireproof area and the first-second wire fireproof area.

8. The battery pack of claim 3, wherein:
the battery housing comprises a base plate and a lateral support member supported by the base plate and extending in a left-right direction; and
the battery modules comprise a third battery module and a fourth battery module disposed to face each other with the lateral support member therebetween.

9. The battery pack of claim 8, wherein the battery pack further comprises:
a second wire disposed between the lateral support member and the third battery module or the fourth battery module, the second wire extending parallel to the lateral support member; and
a second wire fireproof member disposed between the second wire and the lateral support member.

10. The battery pack of claim 9, wherein the second wire fireproof member comprises a second-first wire fireproof area disposed between the lateral support member and the second wire and covering a first side of the lateral support member.

11. The battery pack of claim 10, wherein the second wire fireproof member further comprises a second-second wire fireproof area protruding from the second-first wire fireproof area and extending to surround the second wire together with the second-first wire fireproof area.

12. The battery pack of claim 1, wherein the fireproof member comprises mica, gel, or tape.

13. A battery pack comprising:
a battery housing defining a receiving space;
a plurality of battery modules accommodated in the receiving space, each battery module comprising a battery cell;
a busbar electrically connected to the battery cell and disposed on a first side of the battery modules;
a fireproof member disposed between the busbar and the battery modules, the fireproof member extending to cover the busbar;
a pack cover disposed above the busbar; and
a cover fireproof member disposed between the pack cover and the busbar and extending to cover the busbar.

14. The battery pack of claim 13, wherein the pack cover comprises an injection moldable material.

15. The battery pack of claim 13, wherein the cover fireproof member physically contacts the pack cover.

16. The battery pack of claim 13, wherein a width of the cover fireproof member is thinner than a width of the fireproof member.

17. The battery pack of claim 13, wherein the cover fireproof member comprises mica, gel, or tape.

18. The battery pack of claim 13, wherein:
the busbar comprises:
a first busbar extending in a front-rear direction of the battery housing; and
a second busbar electrically connecting the plurality of battery modules; and
the fireproof member comprises:
a first fireproof area disposed between the first busbar and the battery modules; and
a second fireproof area disposed between the second busbar and the battery modules.

19. The battery pack of claim 18, wherein:
the battery housing comprises a base plate and a longitudinal support member supported by the base plate and extending in the front-rear direction;
the battery modules comprise a first battery module and a second battery module disposed to face each other with the longitudinal support member therebetween; and
the battery pack further comprises:
a first wire extending in the front-rear direction of the battery housing between the first battery module and the second battery module; and
a first wire fireproof member disposed between the first wire and the first and second battery modules, wherein the first wire fireproof member comprises:
a first-first wire fireproof area disposed between the first wire and the first battery module;
a first-second wire fireproof area disposed between the first wire and the second battery module; and
a first-third wire fireproof area disposed under the first wire and connecting the first-first wire fireproof area and the first-second wire fireproof area.

20. The battery pack of claim 18, wherein:
the battery housing comprises a base plate and a lateral support member supported by the base plate and extending in a left-right direction;
the battery modules comprise a third battery module and a fourth battery module disposed to face each other with the lateral support member therebetween;
the battery pack further comprises:
a second wire disposed between the lateral support member and the third battery module or the fourth battery module, the second wire extending parallel to the lateral support member; and
a second wire fireproof member disposed between the second wire and the lateral support member, wherein the second wire fireproof member comprises:
a second-first wire fireproof area disposed between the lateral support member and the second wire and covering a first side of the lateral support member; and
a second-second wire fireproof area protruding from the second-first wire fireproof area and extending to surround the second wire together with the second-first wire fireproof area.
